(19) United States
(12) Patent Application Publication
(10) Pub. No.: US 2026/0217389 A1
(43) Pub. Date: Jul. 30, 2026

(54) ELECTRON CYCLOTRON RESONANCE THRUSTER

(71) Applicant: OFFICE NATIONAL D'ETUDES ET DE RECHERCHES AÉROSPATIALES, Palaiseau (FR)

(72) Inventors: Victor DESANGLES, Palaiseau (FR); Denis PACKAN, Palaiseau (FR); Simon PETERSCHMITT, Palaiseau (FR); Julien JARRIGE, Palaiseau (FR); Paul-Quentin ELIAS, Palaiseau (FR)

(21) Appl. No.: 19/142,009

(22) PCT Filed: Dec. 21, 2023
(86) PCT No.: PCT/EP2023/087459

§ 371 Date: Jun. 20, 2025

(30) Foreign Application Priority Data
Dec. 21, 2022 (FR) FR2214171

(51) Int. Cl. B64G 1/40; H05H 1/10

(52) U.S. Cl. CPC B64G 1/413; H05H 1/10

(57) ABSTRACT

The invention relates to a satellite thruster that employs electron cyclotron resonance and a magnetic nozzle, that extends at least partially along a longitudinal axis (X), and that includes an external conductor and an ionization chamber, the external conductor and the ionization chamber extending longitudinally along this axis, the external conductor bounding the ionization chamber transversely, and the ionization chamber comprising a circular transverse aperture having a diameter D, characterized in that it further comprises a screen coaxial with the longitudinal axis (X), having a maximum transverse dimension D′ such that the ratio of D′ divided by D is between 3 and 15, said screen including a portion made of dielectric material and/or a portion made of electrically conductive material.

### DESCRIPTION

### Technical Field

The present description relates to an electron cyclotron resonance thruster.

### Prior Art

Artificial satellites require thrusters in order to be positioned and held in position and to perform trajectory or attitude correction manoeuvres. Similarly, space probes for exploring the solar system have thrusters that allow them to position themselves very precisely around the selected planet, or even to land on an asteroid to take material samples.

As a general rule, these small thrusters provide thrusts of no more than a few newtons. Chemical thrusters use liquid propellants such as hydrazine (N₂H₂) or hydrogen peroxide (oxygenated water). During the decomposition of these propellants, the chemical energy is converted into heat and then into thrust during the expansion of the hot gases in a suitable nozzle. The material is ejected at high speed and creates a reaction force, called thrust. This thrust is used to change the moment of the spacecraft, probe p or satellite, and to influence its trajectory. A well-known limitation of these technologies is related to the ejection speed that can be achieved by the gases. In addition, the mass of the propellants can reach a significant fraction of the total mass of the satellite, reducing the payload of the satellite, which constitutes a second limitation.

However, it is possible to increase the ejection speed of the propellant gas by several orders of magnitude, using ionized gas particles that are accelerated out of the vehicle by means of electrical and/or magnetic fields. These so-called plasmic or plasma thrusters make it possible to carry out missions with larger trajectory modifications with an equivalent amount of material, or to carry out missions with equivalent trajectory modifications but with less material on board. This reduces the mass of the satellite or increases its payload at a constant mass.

With an increase in the number of new satellites equipped only with a plasma thruster, it is obvious that these thrusters are of great applicative interest. However, they pose many technical challenges.

For example, the first plasma propellants of the ECR (English acronym for “Electron Cyclotron Resonance”) type, i.e. with electron cyclotron resonance, usable by spacecraft, had the disadvantage of not being miniaturisable. Their size was determined by the size of their cavity for coupling the electromagnetic waves with the plasma, as this coupling is necessary for priming the plasma. Patent FR 11 62545 B1 proposes a miniaturised electron cyclotron resonance thruster, consisting in being able to prime the plasma in a very small volume by magnetised-electron resonance (ECR). This is made possible by a special configuration of the ionizing gas inlet, magnetic field lines and electromagnetic-wave coupling.

Nevertheless, it still remains desirable to increase the performance of such thrusters. In addition, problems related to increasing service life persist. Problems with erosion of parts and wear from plasma discharges are still current.

### Technical Problem

From this situation, an aim of the present invention is to provide a novel electron cyclotron resonance thruster that does not have the drawbacks mentioned above, or for which some of these drawbacks are reduced.

### SUMMARY OF THE INVENTION

The invention aims in particular to provide a particularly efficient electron cyclotron resonance thruster. One aspect of the invention thus relates to an electron cyclotron resonance thruster, extending at least partially along a longitudinal axis, comprising an outer conductor and an ionization chamber, the outer conductor and the ionization chamber extending longitudinally along this axis, the outer conductor transversely delimiting the ionization chamber, the ionization chamber including a circular transverse opening 24 including a diameter D, characterised in that it furthermore includes a screen coaxial with the longitudinal axis, including a maximum transverse dimension D′ such that the ratio of D′ divided by D is between 3 and 15, said screen including a part made of dielectric material and/or a part made of electrically conductive material.

Thanks to the invention, it is possible to significantly improve the performance of the thruster. The thrust produced by such a thruster can be multiplied by a factor of 1.3 compared with a plasma thruster of the prior art. The total efficiency of the system, defined herein by the ratio of the power contained in the plasma jet to the electrical power supplied to the thruster is multiplied by a factor of 1.7 compared with a plasma thruster of the prior art. When the thruster is operating and a plasma comprising ions and electrons is ejected, the coaxial screen prevents electrons trapped in the most divergent magnetic field lines from coming into contact with one of the parts of the thruster. Thus, instead of being collected by the thruster in the form of an electric current, these divergent electrons accumulate near the screen, forming a locally negative electrical charge. This allows other divergent electrons to be repelled and thus redirected into the emitted particle beam. The plasma stream ejected by the thruster is thus increased.

According to one aspect of the invention, the part made of dielectric material covers the part made of conductive material. According to one aspect of the invention, the part made of dielectric material completely covers the part made of conductive material. According to one aspect of the invention, the dielectric material part completely covers the conductive material part so that an outer surface of the screen is made of dielectric material.

According to another aspect of the invention, the screen is attached to the outer conductor. According to another aspect of the invention, the thruster comprises a magnetic field source and the screen is attached to the magnetic field source. According to another aspect of the invention, the thruster comprises a body and the screen is attached to the body. According to another aspect of the invention, the thruster comprises a magnetic field source and a body and the screen is attached between the magnetic field source and the body. According to one aspect of the invention, the screen is fastened by means of screws made of dielectric material.

According to one aspect of the invention, the part made of dielectric material is configured to electrically insulate the part made of conductive material from the outer conductor. According to one aspect of the invention, the part made of dielectric material is configured to electrically isolate the part made of conductive material from the rest of the thruster. In this variant, the rest of the thruster includes all thruster elements except the screen.

According to another aspect of the invention, the thruster furthermore includes a dielectric material element configured to electrically insulate the screen from the outer conductor.

According to one variant, the part made of conductive material covers the part made of dielectric material. According to one aspect of the invention, the part made of conductive material completely covers the part made of dielectric material. According to one aspect of the invention, the part made of conductive material completely covers the part made of dielectric material so that an outer surface of the screen is made of conductive material.

According to one aspect of the invention, the part made of an electrically conductive material has a different polarisation from that of the outer conductor or that of another element of the thruster. According to one aspect of the invention, the part made of an electrically conductive material has a different polarisation from that of the outer conductor or that of another element of the thruster other than the screen. According to one aspect of the invention, the part made of an electrically conductive material has a negative polarisation with respect to the outer conductor or with respect to another element of the thruster. According to one aspect of the invention, the part made of an electrically conductive material has a negative polarisation with respect to the outer conductor or with respect to another element of the thruster other than the screen.

Thanks to the invention, it is possible to significantly improve the performance of the thruster. The thrust produced by such a thruster can be multiplied by a factor greater than 1.3 compared with a plasma thruster of the prior art. The total efficiency of the system, defined herein by the ratio of the power contained in the plasma jet to the electrical power supplied to the thruster is multiplied by a factor greater than 1.7 compared with a plasma thruster of the prior art. When the thruster operates and a plasma comprising ions and electrons is ejected, the negatively polarised coaxial screen pushes electrons trapped in the most divergent magnetic field lines and thus allows these divergent electrons to be redirected into the beam of emitted particles. The plasma stream ejected by the thruster is thus increased.

According to another aspect of the invention, the screen is in the form of a disc recessed at its centre or has a flared shape, for example a truncated hollow cone or nozzle.

According to one aspect of the invention, the outer conductor includes an inner wall made of graphite. According to one aspect of the invention, the outer conductor includes an inner wall with an overall cylindrical shape, said inner wall being made of graphite. According to one aspect of the invention, the outer conductor is entirely made of graphite. According to one aspect of the invention, the outer conductor is made of a conductive material and includes an inner wall made of graphite. According to one example, the outer conductor includes a graphite deposit on its inner wall. According to another example, the outer conductor includes a graphite sleeve on its inner wall.

Under the impacts of plasma ions, graphite erodes less than a material of the prior art such as aluminium. Thus the outer conductor has a longer service life. In addition, the plasma electrons that strike the graphite inner wall of the outer conductor are less likely to re-emit electrons by secondary emission, thereby maintaining good plasma containment, and consequently avoiding energy losses from the plasma to the inner wall of the outer conductor. This significantly improves the performance of the thruster. The thrust produced by such a thruster is multiplied by a factor of 1.6 compared with a plasma thruster of the prior art. The total efficiency of the system, defined herein by the ratio of the power contained in the plasma jet to the electrical power supplied to the thruster is multiplied by a factor of 2.5 compared with a plasma thruster of the prior art.

According to one aspect of the invention, the part made of dielectric material is made of a mixture of glass fibre and epoxy resin. According to one aspect of the invention, the part made of dielectric material is made of a mixture of carbon fibre and epoxy resin. This composition makes it possible to obtain a stiffer screen while being lighter and thinner.

According to other embodiment examples, the part made of dielectric material is made of resin or polyimide of the Kapton® type or of ceramic such as alumina or boron nitride or Macor® ceramic.

According to one aspect of the invention, the part made of dielectric material is made of polyetheretherketone (PEEK) or polyetherketoneketone (PEKK).

According to one aspect of the invention, the part made of conductive material is for example a metal reinforcement.

According to one aspect of the invention, the part made of conductive material is made of stainless steel or graphite or aluminium.

According to one aspect of the invention, the part made of dielectric material is a film made of insulating material. For example, the part made of dielectric material is a polyimide film of the Kapton® type.

According to one aspect of the invention, the part made of dielectric material is a polymer-based paint layer, for example a paint layer based on polydimethylsiloxane (PDMS).

According to one aspect of the invention, the part made of dielectric material has a thickness of 200 nanometres to 1 millimetre. According to one aspect of the invention, the part made of dielectric material has a thickness greater than 1 micrometre.

According to one aspect of the invention, the part made of conductive material has a thickness of 200 nanometres to 1 millimetre. According to one aspect of the invention, the part made of conductive material has a thickness greater than 1 micrometre.

A thickness greater than one micrometre allows better durability of the screen, which undergoes erosion related to the space environment.

According to one aspect of the invention, the part made of dielectric material includes a resin reinforcement and a polyimide film of the Kapton® type.

According to one aspect of the invention, the part made of conductive material is bonded to the part made of dielectric material.

According to one aspect of the invention, the part made of dielectric material is bonded to the part made of conductive material.

According to one variant, the outer conductor includes an inner wall and an outer wall separated by a transverse thickness and a uniformization chamber hollowed into said transverse thickness of the wall, said chamber extending longitudinally over a portion of the outer conductor and having an overall hollow cylinder shape. The uniformization chamber allows the gas to be injected evenly around the circumference of the ionization chamber. The uniformization chamber allows the propellant gas to be injected in a controlled manner.

According to another aspect of the invention, the thruster includes means for injecting gas, said means comprising:
at least one injection channel, said channel radially piercing the outer wall of the outer conductor and opening into the uniformization chamber,
the uniformization chamber,
communication means configured so that the uniformization chamber opens into the ionization chamber.

According to one aspect of the invention, the communication means include a transverse circular part partially closing the longitudinal end of the uniformization chamber, said transverse circular part including at least three radial grooves communicating the uniformization chamber with the ionization chamber, or the communication means include orifices radially piercing the inner wall of the outer conductor and opening into the uniformization chamber.

According to one variant, the thruster further includes a so-called “inner conductor” with solid cylindrical geometry, said inner conductor extending along the longitudinal axis in the ionization chamber. According to one aspect of the invention, said inner conductor includes an outer surface made of graphite.

According to one aspect of the invention, the inner conductor is made entirely of graphite. According to another aspect of the invention, the inner conductor is made of conductive material and includes an outer coating of graphite. According to another aspect of the invention, the inner conductor is made of a conductive material and includes on its outer surface a graphite sleeve. According to another aspect of the invention, the inner conductor is made of a conductive material and includes a graphite deposit on its outer surface. Under the impact of plasma ions, graphite erodes less than a prior-art material such as aluminium. Graphite increases the service life of the thruster.

The invention also relates to a method using a thruster according to the invention, the method comprising:
the electrical connection of the part made of electrically conductive material to the negative pole of an electrical supply,
the electrical connection of the external conductor or of another element of the thruster except the screen to the positive pole of the power supply,
putting the power supply and the thruster into operation.

The invention also relates to a device comprising a thruster according to the invention and an electrical supply.

The invention also relates to a device comprising:
an electron cyclotron resonance thruster, extending at least partially along a longitudinal axis, comprising an outer conductor and an ionization chamber, the outer conductor and the ionization chamber extending longitudinally along this axis, the outer conductor transversely delimiting the ionization chamber, the ionization chamber including a circular transverse opening having a diameter D, characterised in that it furthermore includes a screen coaxial with the longitudinal axis, having a maximum transverse dimension D′ such that the ratio of D′ divided by D is between 3 and 15, said screen including a part made of dielectric material and a part made of electrically conductive material, the part made of dielectric material being configured to electrically isolate the part made of electrically conductive material from the rest of the thruster,
an electrical supply including a negative pole electrically connected to the part made of conductive material and a positive pole electrically connected to the outer conductor.

According to one aspect of the invention, the device comprises a thruster which comprises a magnetic field source and a body, the positive pole of the power supply being electrically connected to the magnetic field source or to the body.

According to one aspect of the invention, the device comprises a thrust that which comprises an internal conductor, the positive pole of the power supply being electrically connected to the internal conductor.

Such a device makes it possible to apply a potential difference to the part made of conductive material and to obtain a part made of electrically conductive material negatively polarised with respect to the outer conductor, or to the inner conductor, or to the magnetic field source or to the body of the thruster. When the device operates and a plasma comprising ions and electrons is ejected, the negatively polarised coaxial screen pushes electrons trapped in the most divergent magnetic field lines and thus allows these divergent electrons to be redirected into the beam of emitted particles. The plasma stream ejected by the thruster is thus increased.

According to one aspect of the invention, the device furthermore comprises a measuring unit and a processing electronic circuit configured to control a potential difference applied between the part made of conductive material and the outer conductor or the magnetic field source or the body or the inner conductor.

According to the invention, the outer conductor or the inner conductor or the magnetic field source or the body are referred to as the reference.

The invention also relates to a method for controlling the potential difference applied between the part made of conductive material and the reference by means of a device according to the invention, the method comprising:
a measurement of the potential difference between the part made of conductive material and the reference, called effective potential difference; when the power supply 9 does not apply a potential difference, this potential difference is called floating potential; when the power supply applies a potential difference, the potential difference is called,
a calculation of the difference between the effective potential difference and a predetermined setpoint value,
if the difference exceeds a predetermined threshold, the application of a potential difference to the part made of electrically conductive material of a value equal to the setpoint value by the power supply, the method then resumes at the first step; if the difference measurement does not exceed a predetermined threshold, the method resumes at the first step.

According to one aspect of the invention, the setpoint value is between 10 volts and 1 kilovolt, preferably between 100 volts and 500 volts, in absolute values.

### BRIEF DESCRIPTION OF THE FIGURES

Other features and advantages of the invention will also emerge from the following description, which is purely illustrative and non-limiting, and should be read in relation to the appended drawings on which:

FIG. 1 shows, partially and schematically, a longitudinal cross-sectional view of a thruster according to the invention;

FIG. 2a, FIG. 2b, FIG. 2c and FIG. 2d show, partially and schematically, a longitudinal cross-sectional view of an open coaxial conductor of a thruster according to the invention;

FIG. 3a and FIG. 3b show, partially and schematically, a longitudinal cross-sectional view of an outer conductor and an inner conductor of a thruster according to the invention;

FIG. 4a and FIG. 4b show, partially and schematically, a longitudinal cross-sectional view of a thruster according to the invention;

FIG. 5 shows, partially and schematically, a longitudinal cross-sectional view of a thruster according to the invention;

FIG. 6 shows, partially and schematically, a longitudinal cross-sectional view of a thruster according to the invention;

FIG. 7 shows, partially and schematically, a longitudinal cross-sectional view of a thruster according to the invention;

FIG. 8a and FIG. 8b show, partially and schematically, a longitudinal cross-sectional view of an open coaxial conductor and a screen of a thruster according to the invention;

FIG. 9 shows a diagram of a device according to the invention.

### DETAILED DESCRIPTION OF THE INVENTION

For the sake of clarity, the dimensions of the elements that are shown in these figures do not correspond to actual dimensions, nor to ratios of actual dimensions. Furthermore, some of these elements are shown only symbolically, and identical references which are indicated in different figures denote identical elements or which have identical functions.

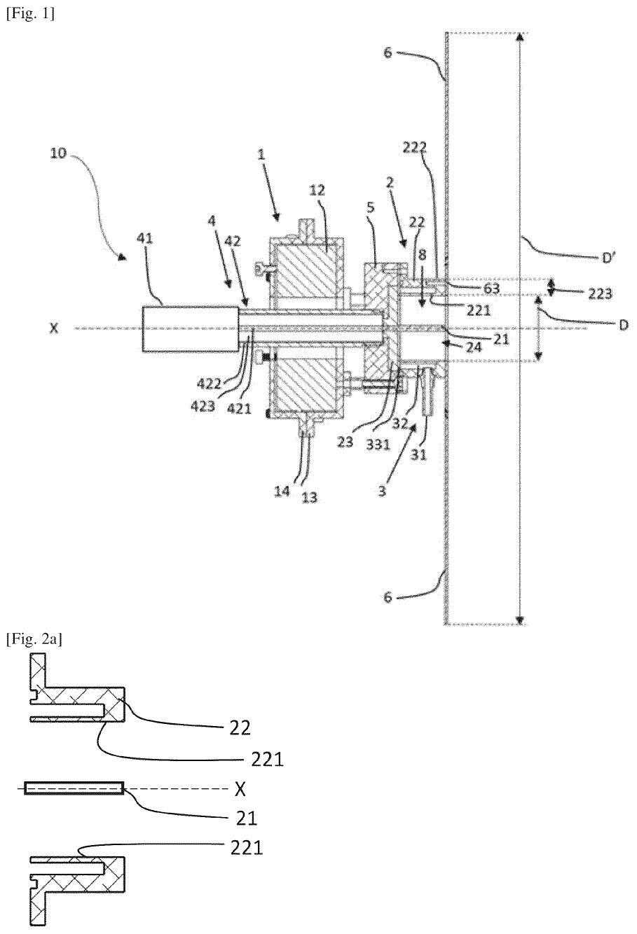

An electronic cyclotron resonance thruster according to the invention has been shown partially and schematically in FIG. 1. This thruster 10 extends at least partially along a longitudinal axis X, and comprises: an open coaxial conductor 2, an ionization chamber 8, gas-injection means 3, a microwave-power injection device 4, a magnetic field source 1, a coaxial screen 6.

The principle of the electron cyclotron resonance satellite thruster is briefly recalled. The means for injecting gas 3 make it possible to introduce a gas into the ionization chamber 8, in which the gas is ionized thanks to the addition of microwaves. Microwaves provide the electrical power required to ionize the gas. They are generated, conveyed and deposited by the microwave-power injection device 4. The signal frequency of the deposited electrical power is between 600 megahertz and 50 gigahertz. The electrical power is transmitted to the propellant gas according to a coaxial geometry described below, or by means of a waveguide. The magnetic field source 1 makes it possible to apply a magnetic field to the plasma and therefore to the electrons thereof. The electrons in the plasma have a gyration movement in the plane perpendicular to the magnetic field, i.e. in a quasi-transverse plane. The frequency of this gyration movement is determined by the value of the magnetic field. The value of the magnetic field and the frequency of the microwave signal are selected such that the gyrofrequency of the electrons is equal to the frequency of the microwave signal. The power provided by the microwave signal will thus be effectively deposited in the electron population of the plasma by a resonance phenomenon. The alternating electric field of the microwave signal will cause the acceleration of the electrons during their gyration movement and the increase of their kinetic energy in the plane perpendicular to the magnetic field, quasi-transverse. The plasma is then maintained with excellent energy efficiency. The electrons created are then ejected at high speeds under the effect of magnetic force and thermal expansion. Electron ejection creates an electrical field that accelerates the ions in the plasma. These are ejected at high speeds, generating the thrust force.

For the rest, the front of the thruster is defined as being the longitudinal end of the thruster through which the propellant gases escape. Thus, in the embodiment in FIG. 1, the coaxial screen is positioned at the front of the thruster. Similarly, the rear of the thruster is defined as the opposite longitudinal end. Thus the microwave-power generator 41 is located at the rear of the thruster.

The thruster comprises an open coaxial conductor 2 including an outer conductor 22 and an inner conductor 21. The outer conductor 22 has an overall hollow cylinder shape, coaxial with the longitudinal axis X and which extends longitudinally along this axis. The inner conductor 21 has a solid cylindrical geometry, extending longitudinally along the axis X, within the outer conductor 22. The thruster comprises a transverse plate 23 called a rear plate having overall a disc geometry. The back plate 23 is in contact with the rear longitudinal end of the outer conductor 22.

The ionization chamber 8 consists of the volume lying between the outer conductor 22, the inner conductor 21 and the rear plate 23. In other words, the ionization chamber is transversely delimited by the outer conductor 22 and it is axially delimited at its rear longitudinal end by the rear plate 23. The ionization chamber includes a transverse opening 24 at its front longitudinal end. This transverse opening 24 allows the propellant gases to escape. The transverse opening 24 is circular and has a diameter D.

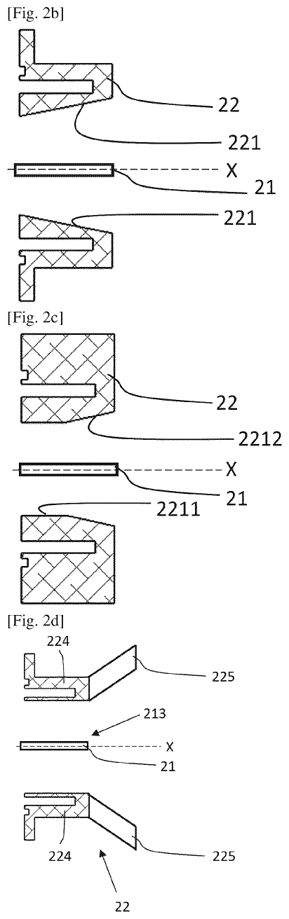

The outer conductor 22 includes an inner wall 221. As illustrated in FIG. 1 and FIG. 2a, the inner wall has a cylindrical geometry. Alternatively, the inner wall 221 has a truncated-cone geometry as illustrated in FIG. 2b. Alternatively, and as illustrated in FIG. 2c, the inner wall 221 includes a first part 2211 of cylindrical geometry at the rear of the ionization chamber 8 and a second part 2212 of truncated cone geometry, the second part being located in line with the first part and the axes of revolution of the first and second parts being coincident with the longitudinal axis X. In the embodiments described previously, the outer conductor is machined in a single block of material. In an embodiment illustrated in FIG. 2d, the outer conductor is manufactured from two separate parts. The outer conductor includes a second truncated-cone geometry portion 225 attached to a first portion 224 with an overall cylindrical geometry, which extends longitudinally beyond the free longitudinal end 213 of the inner conductor 21. Alternatively, the inner-wall geometry is defined by any surface of revolution. The outer conductor makes it possible to contain the propellant gas radially, in order to force its ejection in the axial direction, through the opening 24.

The outer conductor 22 is made of a conductive material. More specifically, according to the invention, the outer conductor is made entirely of graphite. Alternatively, the outer conductor is made of a conductive material and includes on its inner wall 221 a graphite deposit. The graphite deposition is performed using the PVD technique, an acronym for “physical vapour deposition”. For example, the graphite deposition is carried out by plasma or magnetron spraying of a graphite target. A thickness of 10 micrometres of graphite can be obtained by this technique and significantly improves the performance of the thruster. Alternatively, a graphite sleeve is inserted into the outer conductor made of conductive material.

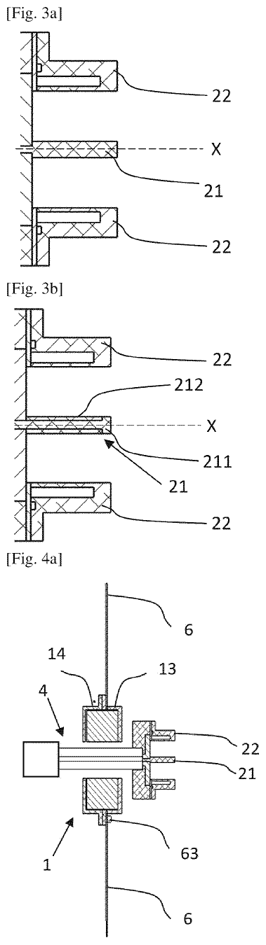

The inner conductor 21 with solid cylindrical geometry extends longitudinally along the axis X. The inner conductor includes an outer surface made of graphite. The inner conductor 21 is for example made entirely of graphite, as shown in FIG. 3a. Alternatively, the inner conductor is made of a conductive material including an outer coating of graphite. For example, the conductive material is coated with a graphite deposit, carried out for example by magnet ron or plasma spraying of a graphite target. A thickness of 10 micrometres of graphite can be obtained by this technique and significantly improves the performance of the thruster. In another example and as shown in FIG. 3b, the inner conductor includes a first part 211 made of conductive material, and a second part 212 made of graphite. The first part 211 includes a first solid cylinder, which extends along the longitudinal axis X, axially extended by a cylindrical head whose diameter is greater than the diameter of the first cylinder. The second portion 212 includes a complementary sleeve of the first portion, such that the assembly of the first and the second portion forms a solid cylinder extending along the X axis in the ionization chamber. In this example, the cylinder head is covered with a graphite deposit, not shown in FIG. 3b.

The outer conductor 22 and the inner conductor 21 form the open coaxial conductor 2 which makes it possible to deposit microwaves in the ionization chamber. The microwaves are generated and provided by the microwave-power generation device 4 which will be described later.

The outer conductor 22 includes an outer wall 222, separated from the inner wall 221 by a transverse thickness 223. The outer conductor includes a uniformization chamber 32 hollowed into said transverse thickness 223. The uniformization chamber 32 extends longitudinally over a portion of the outer conductor 22. The uniformization chamber has an overall hollow cylinder shape.

The gas injection means 3 comprise:
at least one injection channel 31, said channel radially piercing the outer wall 222 and partially the transverse thickness 223 of the outer conductor and opening into the uniformization chamber 32,
the uniformization chamber 32,
communication means configured so that the uniformization chamber opens into the ionization chamber.

The communication means include for example a transverse circular part 331 pressed against the rear plate 23. The transverse circular part 331 partially closes the rear longitudinal end of the uniformization chamber 32. The transverse circular part 331 includes at least three radial grooves communicating the uniformization chamber 32 with the ionization chamber 2. Alternatively, orifices radially piercing the inner wall 221 of the outer conductor and opening into the uniformization chamber are made. In this second embodiment, the rear end of the uniformization chamber is closed directly by the rear plate 23 or by the transverse circular part 331, which does not include a groove in this case.

The propellant gas is injected into the uniformization chamber via at least one injection channel 31. The gas then propagates longitudinally and transversely in the uniformization chamber 32, and then in the ionization chamber via the radial grooves of the transverse circular part 331. The ionization chamber enables the gas to be injected into the ionization chamber in a controlled manner.

The rear plate 23 includes a dielectric material making it possible to accept high thermal loads while being relatively transparent to microwaves. For example, the rear plate is made of ceramic or quartz. The rear plate allows the propellant gas to diffuse to the opening 23 of the thruster. It also receives a significant portion of the heat flow from the plasma. The thruster comprises a body 5 in which the rear plate 23 is integrated.

The body 5 of the thruster is made of a conductive material. The body 5 ensures the mechanical fastening of the various elements of the thruster. It also makes it possible to establish the electrical connection between the microwave-power injection device 4 and the open coaxial conductor 2.

The microwave-power injection device 4 includes a microwave-power generator 41 and a transmission coaxial conductor 42. In an alternative not described herein, the device for injecting the microwave power includes a waveguide 42.

The microwave-power generator 41 produces the microwaves necessary for the operation of the thruster. It produces a signal of a few tens of W (watts) to a few kW (kilowatts) at the frequency of 2.45 GHz (gigahertz). This signal is produced from a direct voltage of a few tens of V (volts) and using microwave oscillator technology. The signal is amplified either by a solid state amplifier or by a field effect amplifier (progressive-wave tube, klystron).

### The Transmission Coaxial Conductor 42

transmits the microwave signal from the generator 41 to the open coaxial conductor 2. The transmission coaxial conductor 42 has an impedance of 50 ohms. It includes a inner conductor 421 and an outer conductor 422 concentric with each other. They are separated from each other by a concentric insulating layer 423, for example made of polytetrafluoroethylene (PTFE) or boron nitride (BN).

The magnetic field source 1 comprises a coil 12 or a set of coils, supplied with electrical current. Alternatively, the magnetic field source comprises a permanent magnet or a set of permanent magnets. For a 2.45 GHz frequency microwave signal, the strength of the magnetic field is adjusted to 875 gauss, so that the electron cyclotron resonance zone is located in the first two centimetres downstream of the rear plate 23. The magnetic field is of high intensity in the source 1 but decreases rapidly at the exit from the thruster, creating a longitudinal magnetic-field gradient. In addition, the magnetic field is locally divergent at the exit of the ionization chamber, creating a magnetic nozzle that contributes to the acceleration of the plasma ions.

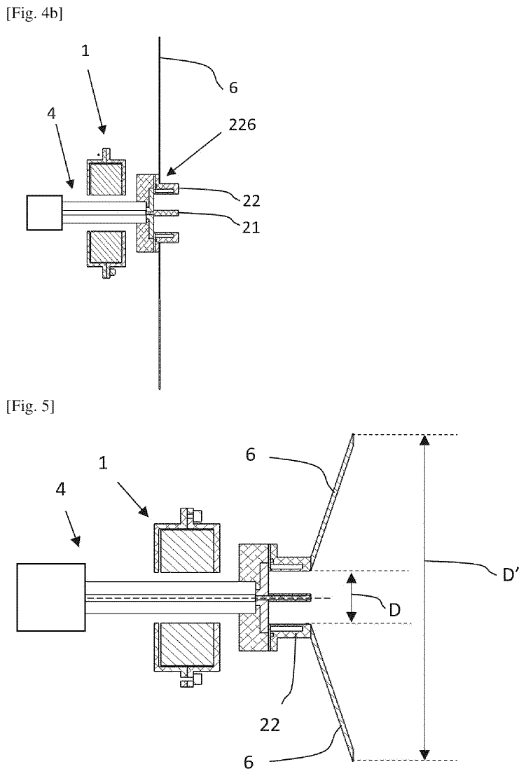

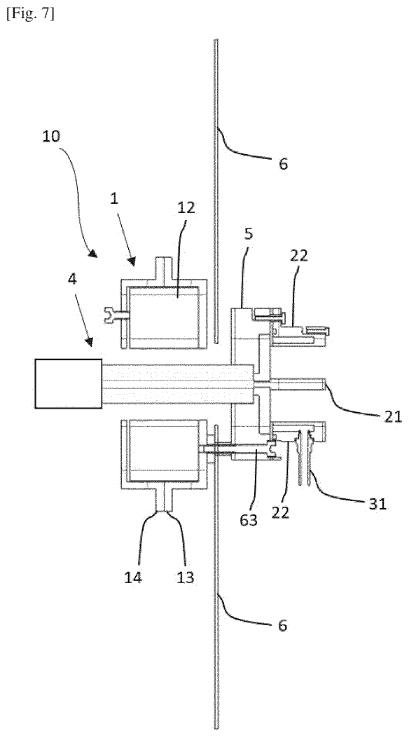

The thruster 10 according to the invention comprises a coaxial screen 6. As shown in FIG. 1, the coaxial screen 6 extends transversely to the axis X. The coaxial screen 6 is directly fastened to the front longitudinal end of the outer conductor 22 by means of three screws 63. Alternatively, the coaxial screen 6 is fastened at another axial position on the outer conductor 22. For example, the coaxial screen 6 is advantageously fastened to the outer conductor 22 at the shoulder 226 that the outer conductor 22 has, as illustrated by FIG. 4b. Alternatively and as illustrated in FIG. 7, the coaxial screen 6 is fastened between the body 5 and the magnetic-field source 1. In this exemplary embodiment, the screen is held by three screws 63 which perforate it and hold the magnetic field source 1 integrally to the body of the thruster 5. Alternatively, and as illustrated in FIG. 4a, the coaxial screen 6 is fastened to the magnetic-field source 1. In this exemplary embodiment, the screen is fastened to the cover 13 by means of screws 63. In another example not illustrated, the screen is interposed between the two covers 13 and 14 which hold the coil 12, the covers 13, 14 and the screen 6 being screwed together along the longitudinal direction.

The coaxial screen 6 includes a disc shape recessed in its centre in order to leave the opening 24 of the ionization chamber free, which allows the propellant gas to be ejected. Alternatively and as illustrated by FIG. 5, the coaxial screen includes a truncated hollow cone shape in its centre.

The coaxial screen 6 has a maximum transverse dimension D′. In the example embodiment in FIG. 1, this maximum transverse dimension is the diameter D′. In the example embodiment in FIG. 5, the maximum transverse dimension D′ is the dimension obtained by projecting the screen along the transverse direction. The maximum transverse dimension D′ is selected so that the ratio D′/D is between 3 and 15. In the example embodiment in FIG. 1, the ratio D′/D is 9. The drawings do not depict this ratio quantitatively. These are illustrations from which no dimensions or dimension ratios can be extracted.

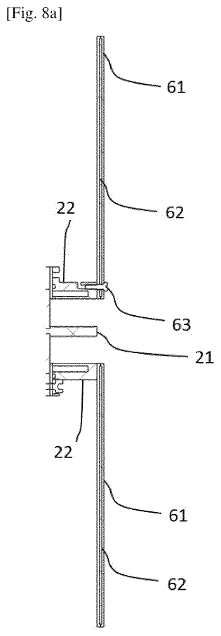

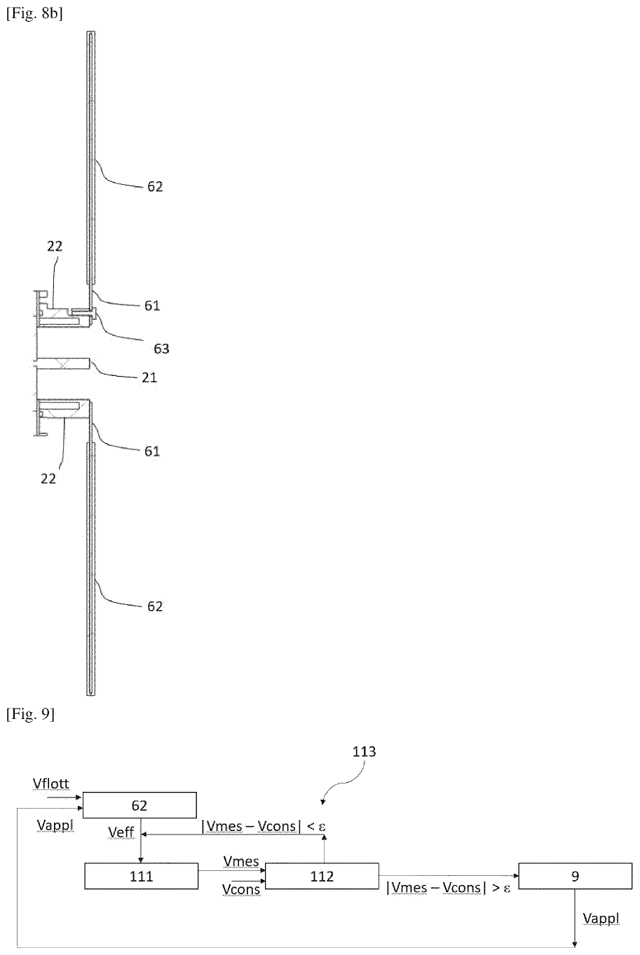

According to the exemplary embodiment in FIG. 1, the coaxial screen 6 is entirely made of dielectric material, here a mixture of glass fibre and epoxy resin. Alternatively, the screen is made of polyimide of the Kapton® type, or ceramic such as alumina or boron nitride. Alternatively, as illustrated in FIG. 8a, the screen includes a portion of conductive material 62 which is covered with dielectric material 61. The part made of conductive material 62 is for example a metal reinforcement, on which a resin 61 is poured. Alternatively, al film 61 made from insulating material is affixed to the metal frame or structure 62. The film 61 is for example made of polyimide of the Kapton® type. The screws 63 may be made of dielectric material, for example polyetheretherketone (PEEK) or polyetherketoneketone (PEKK).

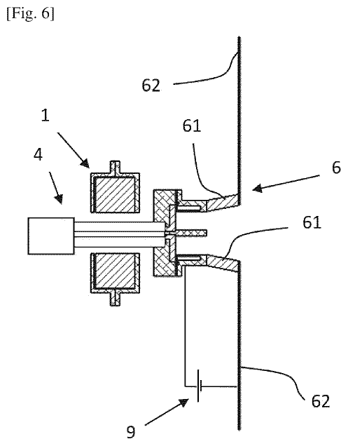

Alternatively, and as shown in FIG. 6 and FIG. 8b, the screen includes a part made from dielectric material 61 and a part made from electrically conductive material 62. The portion 61 made from dielectric material is configured to electrically isolate the part 62 made from conductive material from the other elements of the thruster. The part made from dielectric material 61 is for example in the form of a ring on which the part made from conductive material 62 is fitted and secured. Alternatively and according to the embodiment in FIG. 6, the part made from dielectric material has a conical geometry, in a truncated cone, and is attached in line with the outer conductor 22. The axes of rotation of the part made from dielectric material 61 and of the outer conductor 22 are coincident with the longitudinal axis X. The part made from dielectric material extends longitudinally beyond the free longitudinal end of the inner conductor 21. The part 62 made from conductive material is attached to the part 61 made from dielectric material. The part made from conductive material 62 is for example made of stainless steel, graphite, or aluminium. Screws made of dielectric material may be employed to attach the shield 6 to the outer conductor 22 or to any other element of the thruster 10. For example, if the fastening screws pierce the part made from conductive material 62 and the part made from dielectric material 61 to come to be lodged in the outer conductor 22, screws made of polyetheretherketone (PEEK) or polyetherketoneketone (PEKK) are used. The part 62 made from conductive material is electrically connected to the negative pole of an electrical supply 9, and the positive pole of the supply is connected to the outer conductor 22. When power is turned on, the part made of conductive material polarises negatively. The reference is taken on an earth that is common to the outer conductor 22, to the magnetic field source 1, and to the thruster body 5 which are electrically connected to each other. Alternatively, the reference is taken on any element of the thruster, on the inner conductor 21 for example.

In an embodiment illustrated in FIG. 8b, the part made of conductive material 62 covers the part made of dielectric material 61. The part made of dielectric material 61 is for example a reinforcement, which includes an outer cladding made of conductive material, the latter constituting the part made of conductive material. The cladding is for example obtained by deposition of a conductive material according to the PVD technique. The part made of conductive material 62 may also be bonded to the part made of dielectric material 61. For these example embodiments, the electrostatic potential of the part made of conductive material may not be controlled and be left floating, or be fixed according to the same characteristics described in the previous paragraph, with reference to FIG. 6.

The invention also relates to a device 113 comprising a thruster 10 according to the invention and an electrical supply 9, as shown in FIG. 6.

The device 113 may comprise more elements, as illustrated in FIG. 9. Thus the device 113 comprises:
an electron cyclotron resonance thruster 10, extending at least partially along a longitudinal axis, comprising an outer conductor 22 and an ionization chamber 8, the outer conductor 22 and the ionization chamber 8 extending longitudinally along this axis, the outer conductor 22 transversely delimiting the ionization chamber 8, the ionization chamber including a circular transverse opening 24 having a diameter D, characterised in that it furthermore includes a coaxial screen 6 along the longitudinal axis X, including a maximum transverse dimension D′ such that the ratio of D′ divided by D is between 3 and 15, said screen 6 including a part made of dielectric material 61 and a part made of electrically conductive material 62, the part made of dielectric material 61 being configured to electrically isolate the part made of electrically conductive material 62 from the rest of the thruster,
an electrical supply 9 including a negative pole electrically connected to the conductive material portion 62 and a positive pole electrically connected to the outer conductor 22.

Alternatively, the device 113 comprises a the thruster that comprises a magnetic field source 1 and a body 5, the positive pole of the power supply 9 being electrically connected to the magnetic field source 1 or to the body 5.

Alternatively, the device 113 comprises a the thruster that 10 which comprises an inner conductor 21, the positive pole of the power supply 9 being electrically connected to the inner conductor 21.

The device 113 furthermore comprises a measuring unit 111 and a processing electronic circuit 112 both configured to control a potential difference applied between the conductive material portion 62 and the outer conductor 22 or the magnetic field source 1 or the body 5 or the inner conductor 21.

The outer conductor 22 or the inner conductor 21 or the magnetic field source 1 or the body 5 are called the reference.

The invention also relates to a method for controlling the potential difference applied between the part made of conductive material 62 and the reference by means of a device 113 according to the invention, the method comprising:
a measurement Vmes of the potential difference between the conductive material part 62 and the reference, called effective potential difference Veff; when the power supply 9 does not apply a potential difference, this potential difference is called floating potential Vflott; when the power supply applies a potential difference, the potential difference is called Vappl,
a calculation of the difference & between the effective potential difference Veff and a predetermined setpoint value Vcons,
if the difference & exceeds a predetermined threshold, the application of a potential difference Vappl to the part made of electrically conductive material 62 of a value equal to the setpoint value Vcons by the electrical supply 9, the method then resumes at the first step; if the measurement of difference & does not exceed a predetermined threshold, the method resumes at the first step.

The setpoint value Vcons is comprised between 10 volts and 1 kilovolt, preferably comprised between 100 volts and 500 volts, in absolute values.

1. A satellite thruster with electron cyclotron resonance and magnetic nozzle, extending at least partially along a longitudinal axis, comprising an outer conductor and an ionization chamber, the outer conductor and the ionization chamber extending longitudinally along this axis, the outer conductor transversely delimiting the ionization chamber, the ionization chamber including a circular transverse opening including a diameter D, wherein the thruster further includes a screen coaxial to the longitudinal axis, including a maximum transverse dimension D′ such that the ratio of D′ divided by D is between 3 and 15, said screen including a part made of dielectric material and a part made of electrically conductive material, the part made of dielectric material covering the part made of conductive material, or said screen being entirely made of dielectric material.

2. The thruster according to claim 1, wherein the part made of dielectric material completely covers the part made of conductive material so that an outer surface of the screen is made of dielectric material.

3. The thruster according to claim 1, wherein the screen is attached to the outer conductor.

4. The thruster according to claim 1, wherein the thruster comprises a magnetic field source and a body, the screen being attached to the magnetic field source or to the body, or between the magnetic field source and the body.

5. The thruster according to claim 1, wherein the part made of dielectric material or the screen is made of a mixture of glass fibre and epoxy resin or of carbon fibre and epoxy resin or of resin or of polyimide of the Kapton® type or of ceramic.

6. The thruster according to claim 1, wherein the screen includes a resin reinforcement and a polyimide film of the Kapton® type.

7. The thruster according to claim 1, wherein part made of conductive material is a metal reinforcement.

8. The thruster according to claim 1, wherein the screen includes a disc shape recessed at its centre or includes a flared shape, nozzle.

9. The thruster according to claim 1, wherein the outer conductor includes an inner wall made of graphite.

10. The thruster according to claim 9, wherein the outer conductor includes an inner wall and an outer wall separated by a transverse thickness and includes a uniformization chamber hollowed into said transverse thickness, said uniformization chamber extending longitudinally over a portion of the outer conductor and having an overall hollow cylinder shape.

11. The thruster according to claim 10, wherein the thruster further includes means for injecting gas, said means comprising:
at least one injection channel, said channel radially piercing the outer wall and partially piercing the transverse thickness of the outer conductor and opening into the uniformization chamber,
the uniformization chamber,
communication means configured so that the uniformization chamber opens into the ionization chamber.

12. The thruster according to claim 11, wherein the communication means include a transverse circular part partially closing the longitudinal end of the uniformization chamber, said transverse circular part including at least three radial grooves communicating the uniformization chamber with the ionization chamber, or the communication means include orifices radially piercing the inner wall of the external conductor and opening into the uniformization chamber.

13. The thruster according to claim 1, wherein the thruster furthermore comprises a so-called inner conductor with solid cylindrical geometry, said inner conductor extending along the longitudinal axis in the ionization chamber, said inner conductor including an outer graphite surface.
